(19) United States
(12) Patent Application Publication
(10) Pub. No.: US 2025/0387669 A1
(43) Pub. Date: Dec. 25, 2025

(54) VIDEO RECORDING DEVICE FOR PERSONAL FITNESS ANALYSIS

(71) Applicant: Phillip Gervais, Davie, FL (US)

(72) Inventor: Phillip Gervais, Davie, FL (US)

(21) Appl. No.: 19/222,995

(22) Filed: May 29, 2025

Related U.S. Application Data
(60) Provisional application No. 63/664,134, filed on Jun. 25, 2024.

(51) Int. Cl. A63B 24/00

(52) U.S. Cl. CPC A63B 24/0006; A63B 24/0062

(57) ABSTRACT

A dual video recording system and method can capture simultaneous multiple angles of exercises using a first and a second camera for recording video and a processor that compiles the video data from the first and second cameras. The compiled video may be analyzed by transmitting it to a physical health professional for analysis, transmitting it to an artificial intelligence capability for training a machine learning model and/or for analysis by a machine learning model, or may be analyzed by the processor. The analysis may include generating a stick figure model representing the exercise actions, and this model may be used to generate the graphic interpretation overlaid over video of the exercise to provide feedback.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### FIELD OF THE INVENTION

The invention relates to the field of using recorded video to facilitate analysis of physical exercises performed by a subject to evaluate the effectiveness of their exercise technique.

### BACKGROUND OF THE INVENTION

More and more people are choosing to prioritize their physical health than ever. Today, there is a heightened awareness of the importance of fitness, driven by a surge in health consciousness and the proliferation of digital technology.

Personal training and physical therapists (physical health professionals) are in high demand. Unfortunately, accessibility to physical health professionals in this field is limited by price and geography. Exercises prescribed must currently be observed by fitness professionals in person, to ensure their clients do not harm themselves, or remotely via smartphones or other conventional video recording devices. A study published in the American Journal of Sports Medicine found that the key to the prevention of injuries in recreational weightlifters and bodybuilders is having professional supervision and adhering to proper lifting techniques. Current solutions are expensive, restricted to a physical location, and/or do not offer live feedback and corrections while exercises are being performed.

Physical health professionals may not be readily available in all areas, especially in rural or remote regions. In such areas, individuals may have to travel long distances to access a physical therapist or personal trainer, which can be costly and time-consuming. For individuals without access to reliable transportation, getting to physical therapy or personal training appointments can be a significant challenge. This lack of proximity can result in delayed or inadequate treatment, leading to poorer health outcomes. People with physical disabilities may also face additional barriers due to issues such as lack of accessible facilities or specialized training needs. A study published in the Journal of Rehabilitation Research and Development concluded that use of telerehabilitation was associated with minimizing the time, expense, and inconvenience of receiving rehabilitative care.

According to a recent Forbes article about the cost of physical therapy, an initial evaluation visit at a private office typically costs between $150 and $200. At a hospital facility, the cost would range from $400 to $500. A follow-up visit may cost $80 to $120 at a private office and $300 to $400 at a hospital facility. These numbers will vary based on region as well as other factors. With increased accessibility, physical health professionals may be able to serve more clients, leading to economies of scale. In other words, the cost per session or per client could decrease as the volume of clients increases, making these services more affordable for individuals. There are also additional savings in reduced overhead costs, a physical health professional could even provide this service from home. Improved accessibility can lead to an increase in demand for physical health services. As more people seek these services, there may be more opportunities for physical health professionals to expand their client base and increase their earnings.

There are very limited options for remote work for physical health professionals. Most options for people require the purchase of expensive workout equipment such as Peloton or Mirror fitness equipment, and live feedback is not provided as well. There are a few apps that create workouts and display them to a user through an application such as Zing Coach. However, there is no live feedback to ensure exercises are being performed correctly. Kickoff allows people to connect with personal trainers, but is lacking in technology to view the exercises. Trainers simply provide plans and coaching without direct involvement in the activity being performed. In-person options are available for most people. However, this requires going to a physical location and options are limited within a drivable distance (or accessible distance via other transportation for users who do not drive).

### BRIEF SUMMARY OF THE INVENTION

The present disclosure relates to the use of fitness models, and more specifically to recording simultaneous video of exercises from multiple angles and for analysis to provide feedback to a user in properly performing the exercises.

According to one aspect of the present disclosure, a system for recording a user's exercise actions to analyze their exercise may have a first camera, a second camera that can be positioned relative to the first camera to cover an overlapping field of view of an exercise area from a different angle, one or more processors in electrical signal communication with the first and second cameras to receive video data therefrom and at least one instruction set that directs the processor(s) to compile video data from the first and second cameras to generate compiled video data that correlates recorded actions taken by a person within the exercise area from two different angles. The instruction set(s) may direct the processor(s) to perform at least one analysis action selected from the group of:
operating a communications capability to transmit at least a portion of the compiled video data to a physical health professional,
operating a communications capability to transmit at least a portion of the compiled video data to an artificial intelligence capability that employs the recorded actions taken by the person within the exercise area to compare the body positions and/or motion of the person for training at least one machine learning model,
operating a communications capability to transmit at least a portion of the compiled video data to an artificial intelligence capability that performs an analysis of the recorded actions taken by the person within the exercise area to evaluate the body positions and/or motion of the person using at least one machine learning model, and
performing an analysis of the recorded actions taken by the person within the exercise area to compare the body positions and/or motion of the person against at least one reference for proper performance of a specified exercise to provide an indication of compliance.

According to further aspects of the disclosure, the system may have one or more of the following features. The instruction set(s) may direct the processor(s) to perform an analysis of the recorded actions taken by the person within the exercise area, where the analysis includes generating a stick figure model representing the actions of the person while exercising. Where the system includes a visual display, the instruction set(s) may direct the processor(s) to present on the visual display a side-by-side view of at least a portion of the compiled video data from the first and second cameras with a graphic representation based on the stick figure model overlaid onto the views. The at least one processor of the system may include a central processing unit that is mounted in a housing that also houses the first camera. Such housing may be supported on a first tripod, and the second camera may be supported on a second tripod. The instruction set(s) may include instructions for guiding a user in positioning the second camera relative to the first camera to obtain the overlapping field of view of the exercise area from a different angle. The system may employ a first device that houses the first camera and a first CPU (which provides at least a portion of the at least one processor and is in electrical signal communication with a personal electronic device) and which is positionable on legs, and a second device that houses the second camera and is in electrical signal communication with at least one of the first CPU and the personal electronic device, the second device also being positionable on legs. Portions of the system, such as the first camera, at least one processor, and at least one instruction set, may be provided by an application operating on a personal electronic device having a camera, processing capability, storage capability, and telecommunications capability. In either of the above cases, the personal electronic device may be a smart telephone, a laptop computer, or a tablet computer.

According to another aspect of the present invention, a method for recording the exercise actions of a person for analysis may include the steps of recording first camera video data from a first camera positioned to cover a field of view of an exercise area, recording second camera video data from a second camera positioned to cover an overlapping field of view of the exercise area, from a different angle than the first camera, compiling the first camera video data and the second camera video data to generate compiled video data that correlates recorded actions taken by a person within the exercise area from two different angles, and employing the compiled video data to perform at least one analysis step. The analysis step(s) may be selected from the group of:
transmitting at least a portion of the compiled video data to a physical health professional,
transmitting at least a portion of the compiled video data to an artificial intelligence capability that employs the recorded actions taken by the person within the exercise area to compare the body positions and/or motion of the person for training at least one machine learning model,
transmitting at least a portion of the compiled video data to an artificial intelligence capability that performs an analysis of the recorded actions taken by the person within the exercise area to evaluate the body positions and/or motion of the person using at least one machine learning model, and
performing an analysis of the recorded actions taken by the person within the exercise area to compare the body positions and/or motion of the person against at least one reference for proper performance of a specified exercise to provide an indication of compliance.

According to further aspects of the present disclosure, the method may include the step of performing an analysis of the recorded actions taken by the person within the exercise area, wherein the analysis further comprises the step of generating a stick figure model representing the actions of the person while exercising. The method may further include the step of generating a visual display showing a side-by-side view of at least a portion of the compiled video data from the first and second cameras with a graphic representation based on the stick figure model overlaid onto the views. The method may include the step of guiding a user in positioning the second camera relative to the first camera to obtain the overlapping field of view of the exercise area from a different angle. The step of recording first camera video data may be performed using a first device having a first CPU, the step of recording second camera video data may be performed using a second device, and the step of compiling the first camera video data and the second camera video data may includes the step of transmitting the second camera video data from the second device to at least one of the first device and a personal electronic device. At least some of the steps may be performed by an application operating on a pre-existing personal electronic device, such as the steps of compiling the first camera video data and the second camera video data and employing the compiled video data. In either of the above cases, the personal electronic device may be a smart telephone, a laptop computer, or a tablet computer.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIGS. 1A and 1B show one example of dedicated video recording devices that can communicate with a user personal electronic device (not shown) to record and process video data of a person exercising, as components of a system for recording video from multiple angles for analysis;

FIG. 1C shows one example of a data workflow that can be employed in a system using devices such as those shown in FIGS. 1A and 1B; and

FIG. 2 shows a sample UI for prescriber of exercise personal electronic device.

FIG. 3 shows a block diagram of one example of a system for recording and processing videos of an exercise activity; and

FIG. 4 is a flowchart showing one example of a method for recording and processing videos of an exercise activity.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

“Personal electronic device” may refer to a dedicated device or a pre-existing device running software to provide functions of the system or method. Such devices include, but are not limited, to smart telephones, laptop computers, desktop computers, and tablet computers.

As this invention is susceptible to embodiments of many different forms, it is intended that the present disclosure be considered as an example of the principles of the invention and not intended to limit the invention to the specific embodiments shown and described.

Presented is a system and/or method that that allows simultaneous video recording of exercises from two different angles. The video can be transmitted to a personal electronic device (smartphone, laptop, etc.) and may be transmitted for viewing on a website/app by a physical health professional for analysis. The exercise and analysis can be stored on a database for future training of AI models for analyses. When a sufficiently trained AI model is available, such model may be used to provide real-time or nearly real-time analysis to provide feedback to the user in exercising properly. By providing compiled video recording from multiple angles, the system and/or method can provide physical health professionals and those in need of them the capability for remote analysis of exercises. This can provide greater access to review and analysis for those located in more rural areas, as well as reduce costs. This can make it so that someone can access a physical health professional that would meet their needs, as well as provide more work opportunities for the physical health professional. The system and/or method can also allow for additional technologies such as overlay graphics to assist with exercise analysis, AI analysis of exercises, customized nutrition recommendations, etc.

One aspect is directed to system for capturing simultaneous multiple angles of exercises using a first camera and a second camera, which can be positioned to recording video of an exercise area from two different angles. Additional cameras could be employed to provide additional angles, but for conciseness the system and method are described herein for cases where only two cameras are employed. The video from the cameras is complied by a processor to provide a compiled video, reflecting simultaneous exercise actions viewed from two angles. The compiled video is then used for one or more analysis actions, which may include transmitting the compiled video to a health care professional for review and analysis, transmitting the compiled video to an artificial intelligence capability for use in training a machine learning model, transmitting the compiled video to a trained artificial intelligence capability for analysis, and/or analyzing the compiled video locally to provide feedback to a user. Some or all components of the system may be provided by dedicated devices, and some components may be provided by pre-existing computing devices such as a smartphone, a laptop or other mobile device.

Another aspect is directed to a method for analyzing exercise performance. The method may include capturing video of an exercise performer from two different angles using at least two cameras, and compiling the captured video for analysis. The analysis may include generating a stick figure model of the exercise actions, and the method include displaying the video feeds from the two angles side by side on a user interface, overlaying a stick figure image of the performer in the video to highlight exercise mechanics. The stick figure image overlaid on the performer in the video may be generated by an artificial intelligence model. The compiled video and/or any analysis data generated may be stored in a database for training of artificial intelligence models.

Another aspect is directed to a system for remote physical therapy and personal training. The system includes a dual video recording device for capturing video of exercises from multiple angles, a processor for receiving and displaying the captured video and a user interface for displaying the video feeds side by side and providing additional information about the exercise performer. The system can include a database for storing exercise and analysis data and back-end software for transmitting the video data to a physical health professional for analysis and feedback. The system may employ a central processing unit with wireless transmission capabilities for transmitting the captured video to the personal electronic device. The personal electronic device may be a smartphone, laptop, or other mobile device. The video feeds may be displayed side by side on a user interface of a website or application. The user interface may allow overlaying a stick figure image on the performer in the video to highlight exercise mechanics. The exercise and analysis data stored in the database may be used for training of an artificial intelligence model to provide feedback for basic exercises.

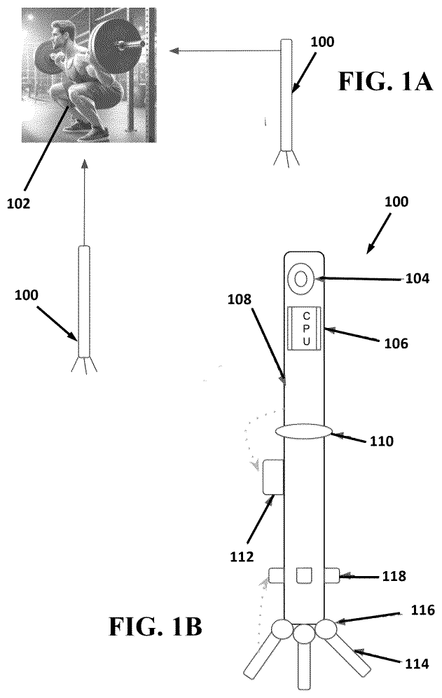

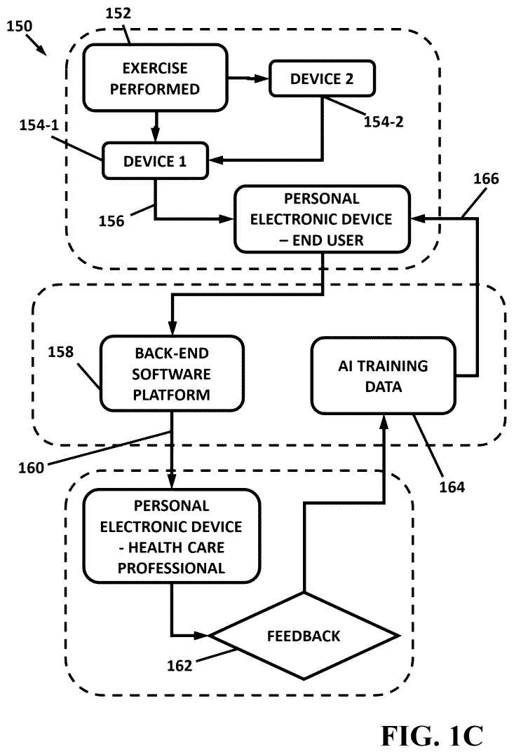

FIG. 1A shows one example of a pair of dedicated devices 100 that can record video of a person 102 performing an exercise (described herein as the ‘end user”). FIG. 1B shows one of the devices 100 in greater detail. Each device 100 has a video camera 104 and a CPU 106 with wireless transmission capability, both housed in a main device tube 108. The tube 108 may house additional components, such as a power supply or power adapter to operate the camera 104 and the CPU 106. The tube 108 may have a tube joint 110 to allow it to be folded for compact transportation or storage. When the tube 108 is folded, it may be secured in its folded state by a tube receiving and locking piece 112 (the device may be provided with a latching structure for locking it in the unfolded position as well, such as an internal latch structure, not shown). A plurality of legs 114 (typically three) are mounted to one end of the tube 108, and may be joined to the tube 108 by leg joints 116 that allow the legs to be folded alongside the tube 108. The folded legs 114 may be secured in their folded position by leg receiving and locking pieces 116 (the legs may also be locked when in their extended position). When unfolded, the legs 114 provide a tripod to allow the device 100 to be positioned relative to an exercise area to allow the cameras 104 on the devices 100 to record the exercise area from two different angles, such as being aimed at the user 102 at a perpendicular angle to each other. In some cases, the devices 100 may guide the user in positioning the cameras 104, such as by analyzing the video data from the cameras 104 or other information provided by the devices 100 to obtain sufficiently different fields of view. While the devices 100 shown incorporate legs for support, devices could use alternative supports such as stands, clamps, beanbags, etc., and could be designed to use pre-existing supports such as conventionally used for supporting videography equipment.

FIG. 1C illustrates one example of a data workflow 150 that could be employed by a system using a pair of video recording devices such as the devices 100 shown in FIGS. 1A & 1B. The data workflow 150 is centered around the transmission of the live video data generated by recording an end user (such as user 102 shown in FIG. 1A) while performing an exercise activity (152). Video of the exercise activity is captured (154-1) via Device 1 and is captured and transmitted (154-2) by Device 2. In the illustrated data workflow 150, a processor in Device 2 (which can be similar to the CPU 106 shown in FIG. 1B) can transmit video to a processor in Device 1 to be compiled, then transmitted (156) to a personal electronic device of the end user (in this scheme, Device 2 may be considered in electronic signal communication with the end user personal electronic device via Device 1). Variations are possible, such as Device 2 not having a processor but merely serving as a remote camera controlled by the processor in Device 1, or for Device 2 to be in direct communication with the end user personal electronic device.

From the personal electronic device, the compiled video data can be sent to back-end software that can tag it to determine an appropriate route (158), and transmit it (160) to a personal electronic device of a health care professional (typically the one who has prescribed the exercise) for analysis. It should be appreciated that alternative data handling schemes could be employed, such as for both devices to transmit to the end user personal electronic device rather than one first transmitting to the other, for the video data to be compiled at a different stage of processing (such as by the personal electronic device of the end user, by the back end software, and/or by software located on and/or accessible to the personal electronic device of the health care professional). One or both Devices 1 and 2 could be equipped to communicate directly with the back-end software without going through an end user personal electronic device. However, the use of the personal electronic device can allow the system to coordinate its operation with other personal applications of the end user, such as calendar applications, health/fitness tracking applications, account management/payment applications, etc.

The back-end software may tag the video data with an identifier associated with the end user, and may use such identifier to match an appropriate health care professional to whom the data should be sent, as well as possibly maintaining a record over time for the end user. While direct connections are shown, intermediate connections/relays may be employed; for example, the back-end software may transmit data to a centralized health care network, form which it is routed to the health care professional, rather than transmitting directly to a personal device of the health care professional.

Once the video data for the exercise has been received by the health care professional, it is analyzed and any feedback determined (162). This could be done simply by the health care professional viewing the video, or could be done with analysis aids such as by using a trained AI capability. The presentation to the health care professional may display the video feeds from the two cameras side by side, and a third section could provide additional information regarding the end user and/or the exercise being performed. A stick figure model could be generated based on the video recordings, and used to generate an image that can be overlaid on the video image of the user to better highlight correct or incorrect mechanics in the exercise being performed.

Such stick figure model may be generated by an AI capability analyzing the video to correlate the image of the end user as they perform the exercise to positioning and/or motion of the body parts of the user, and possibly the positioning and/or motion of exercise equipment being used. The analysis may track the positions (as indicated by the recorded video) of particular major bones, joints, and or major body portions of interest for the particular exercise to correlate such apparent positions to a known model of human anatomy. Such stick figure model may vary in resolution as appropriate for the indented use. A high-resolution model might attempt to consider the position of all the user's bones and joints (at least within a particular region of interest), while a lower resolution model may only consider major joints and limb segments (for example, representing the forearm and lower leg each as a single line for both bones, and/or representing the spine as a single line or curve rather than as a series of individual vertebrae). The stick figure model may also include force vectors appropriate to the exercise, such as gravitational force of a lifted weight or the vector force of a piece of exercise equipment that generates resistance force for the user. The AI capability may attempt to match the stick figure model to known models for the particular exercise to identify whether or not and/or to what degree the end user's performance (as indicated by the video data) complies with an acceptable range of positions, motions, alignments, etc. for performing the exercise. For example, comparing the stick figure model to an accepted model may identify any areas where the end user's performance shows misalignment, imbalance, over-extension or under-extension of a joint, or other position-based and/or motion-based indication that the end user is not performing the exercise correctly.

Feedback may be based solely on the expertise of the health care professional or may be informed by a trained AI capability. In the illustrated data 150 workflow, the compiled video, analysis (including stick figure model analysis) and any feedback are transmitted to a centralized database and stored (164) for use in training an AI capability to improve its analysis capability and/or to develop options for automated assistance of analysis of the exercise. As one example, the AI capability may be trained to identify unsafe situations to allow software operating on the end user personal device to provide the user with a real-time warning when they begin to perform an exercise in an unsafe manner. The information stored in the database may include additional information regarding the particular end user, the particular exercise, the particular equipment used to perform the exercise, or any other data than may be relevant to analysis. The analysis and feedback are also sent to the personal device of the end user (166) for presentation and review by the end user, to inform them as to any adjustments that they should make for performing the exercise in the future. This presentation may show the end user the side-by-side display of videos with the stick figure representation overlaid, optionally with annotations to point out any particular areas where the end user should make adjustments.

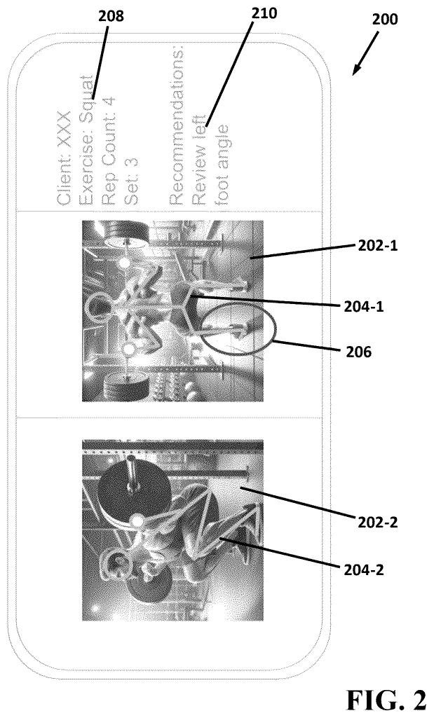

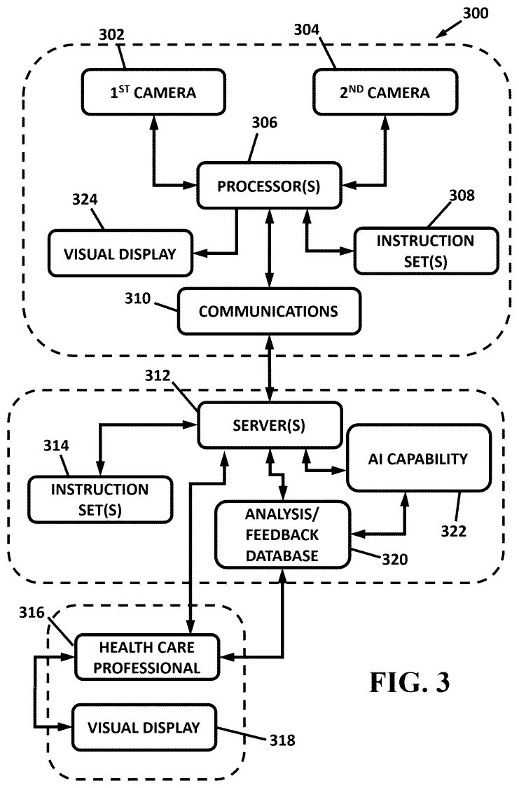

FIG. 2 shows a sample display interface 200 for use by a health care professional (or other prescriber/monitor of exercise) on a personal electronic device. The end user could be presented with an interface presenting similar information (or a subset thereof). The display 200 includes video images 202-1 & 202-2, representing the recorded video from a first camera (202-1) and a second camera (202-2). Overlaid on these images are stick figure renderings 204-1 & 204-2, which more clearly represent the position and alignment of the parts of the end user's body as they perform the exercise. The simplified stick figure rendering more clearly shows the arrangement of the end user's body, and therefor makes it easier to evaluate the end user's position and motion. In the example shown in FIG. 3, the stick figure rendering 204-2 shows the left foot of the end user misaligned, and the health care professional can add annotation 206 (a red circle around the foot) top point out the misalignment to the end user. The display 200 also includes a text field 208 which can display end user information 210 as well as any text recommendations 212.

FIG. 3 is a block diagram showing functional components of one example of a system 300, which can record video using a first camera 302 and a second camera 304 located where an end user performs an exercise activity to be recorded. The cameras (302, 304) communicate with one or more processors 306, which operate one or more instruction sets 308 and can access a communications capability 310. The processor(s) 306 may include one or more processors incorporated into dedicated devices (such as the CPU 106 of the device 100 shown in FIG. 1B) and/or may include a personal electronic device (which may also provide one of the cameras 302, 304 and/or the communications capability 310). The instructions set(s) 308 direct the processor(s) 306 to compile the video recordings from the two cameras (302, 304) and transmit them, via communications capability 310, to one or more servers 312.

The server(s) 312 can be operated at one or more central facilities to serve a number of end users and heath care professionals (only one of each is shown for clarity), and operates one or more instruction sets 314 (which may include instructions to perform the functions of the back-end software used to tag and route compiled video data in FIG. 1C). The instruction sets 314 can allow the server(s) 312 to direct the compiled video data to an appropriate health care professional 316 that matches the end user. The received data may be displayed on a visual display 318 for analysis by the health care professional 316. The compiled video data (and any analysis and/or feedback data entered by the health care professional 316) may be stored in an analysis/feedback database 320, and may be used to train an AI capability 322. Once trained, the AI capability 322 may provide analysis functions to the server(s) 312 for presentation to the health care professional 316. Analysis and feedback from the health care professional 316 can be sent via server(s) 312 and communications capability 310 to the end user processor(s) 306, and can be used to generate a visual display 324 for presentation to the user to guide them in performing the exercise correctly.

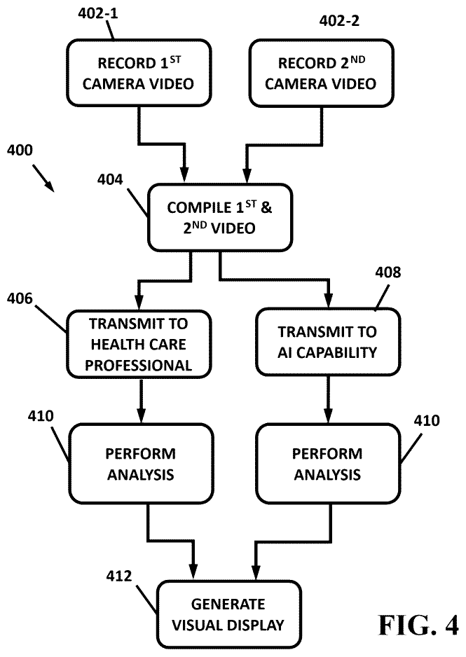

FIG. 4 illustrates one example of a method 400, which starts with recording video from a first camera (step 402-1) and from a second camera (402-2) while an end user performs an exercise activity that the cameras record from different angles. The video from the two cameras is compiled (step 404) and is then transmitted to one or both of a health care professional (step 406) and an AI capability (step 408). In either case (or both cases), the compiled video is analyzed (step 410) to evaluate the performance of the exercise by the end user. Such analysis may include generating a stick figure model of the positions and/or motions of the end user while performing the exercise, to more clearly evaluate alignment and other parameters of exercise mechanics. The resulting analysis is used to generate a visual display 412, which may be a visual display for the health care professional and/or for the end user.

While systems and methods employing two cameras are illustrated and described, one or more additional cameras could be employed to provide further video data for analysis.

The system and/or method allows for increased access to physical therapy and personal training for people who prefer, or need, remote access to these services. The device also has the additional benefit of increasing access to clients for these physical health professionals. Collected data can be used for AI model training to provide feedback for basic exercises and ultimately expand access to these services to an even broader population. In some systems, human oversight is required in order to understand an individual's physical capabilities and prescribe appropriate exercises.

The present disclosure provides a system and method for capturing and analyzing physical exercises. This system may include a dual video recording device capable of capturing simultaneous video footage from multiple angles. The device may comprise components such as cameras, a central processing unit (CPU) with wireless transmission capabilities, and a structural frame that may include a main device tube, joints for folding, and legs for support.

By recording physical exercises from different perspectives, a comprehensive view of the exercise performance can be attained. The recorded video data may be transmitted to a personal electronic device, such as a smartphone or laptop, for further analysis. This analysis may be performed by a physical health professional and/or by a trained artificial intelligence (AI) model, depending on the specific implementation.

The system may also include a user interface for viewing the recorded video data, providing feedback, and storing exercise and analysis data in a database. This database may be used for future training of AI models, potentially enhancing the accuracy and efficiency of exercise analysis.

The system and method disclosed herein may offer increased access to physical therapy and personal training services, particularly for individuals who prefer or require remote access. Furthermore, the system may facilitate the collection of exercise data, which could be used to train AI models and expand the accessibility of these services to a broader population.

The system may overlay a stick figure image on the video footage to highlight potential inaccuracies in the exercise mechanics. Feedback from the physical health professional may be provided verbally or in text form, and this feedback may also be stored in the database for future reference and AI model training.

While a human professional may be involved in understanding an individual's physical capabilities and prescribing appropriate exercises, the system may also incorporate AI models to assist in the analysis and feedback process. This combination of human expertise and AI capabilities may provide a comprehensive and efficient approach to remote physical therapy and personal training services.

The dual video recording device may be designed to capture simultaneous video footage of exercises from two different angles. This device may include a first and a second camera, each positioned to record a distinct perspective of the exercise performance. The cameras may be configured to transmit the recorded video data to a central processing unit (CPU), which may be housed within a housing of the device. The CPU may have wireless transmission capabilities, enabling it to send the compiled video data from both cameras to a personal electronic device.

The main device tube may serve as the structural backbone of the device, housing the CPU and providing support for the cameras. In some cases, the device may include a joint for folding the main device tube, allowing for compact storage and easy transportation. A receiving and locking piece may be included to secure the folded main device tube, ensuring stability and safety during transport and storage.

The device may also include a pair of legs for supporting the device during use. These legs may be foldable, with a joint for folding the legs included in the design. A receiving and locking piece may be provided for securing the folded legs, further enhancing the portability of the device. The system may be used for remote physical therapy and personal training. The dual video recording device may capture video of exercises performed by an individual, and the video data may be transmitted to a personal electronic device for viewing and analysis. This may allow physical health professionals to provide remote services, analyzing the exercise performance and providing feedback to the individual. The system may also enable individuals to access physical therapy and personal training services remotely, increasing the accessibility of these services.

The system may include a user interface for displaying the video feeds side by side, providing additional information about the exercise performer, and overlaying a stick figure image on the performer in the video to highlight exercise mechanics. The user interface may be part of a website or application, and may be accessible via the personal electronic device. The system may also include a database for storing exercise and analysis data, and back-end software for transmitting the video data to a physical health professional for analysis and feedback. The stored data may be used for future training of AI models, potentially enhancing the system's ability to provide feedback for basic exercises.

The dual video recording device may include a first camera and a second camera. These cameras may be strategically positioned to capture video footage of exercises from two distinct angles. This dual-angle recording capability may provide a comprehensive view of the exercise performance, potentially enhancing the accuracy of the subsequent analysis.

The first and second cameras may be configured to record video data, which may include visual information about the exercise performance. In some cases, the cameras may be equipped with high-resolution sensors to capture detailed video footage. The cameras may also include features such as autofocus and image stabilization, which may contribute to the quality of the recorded video.

The first and second cameras may be positioned on different sides of the device. For instance, the first camera may be positioned on the front side of the device, while the second camera may be positioned on the side or rear of the device. This arrangement may allow the cameras to capture video footage from different perspectives, providing a multi-dimensional view of the exercise performance.

The first and second cameras may be positioned at different heights on the device. For example, the first camera may be positioned at a higher level to capture a top-down view of the exercise performance, while the second camera may be positioned at a lower level to capture a side view. This arrangement may provide a comprehensive view of the exercise performance, potentially enhancing the accuracy of the subsequent analysis. The first and second cameras may be adjustable, allowing the user to modify the recording angles as per their requirements. This flexibility may enable the user to capture video footage from the desired angles, potentially enhancing the utility of the device. The first and second cameras may transmit the recorded video data to the central processing unit. This transmission may occur via wired or wireless connections, depending on the specific implementation. The central processing unit may then compile the video data from both cameras and transmit the compiled video data to a personal electronic device for further analysis.

As shown in FIG. 1B, the device 100 may include a CPU 106 that serves as a core component of the dual video recording device 100. The CPU 106 may be housed within the main device tube 108, providing a secure and compact location for this integrated component. The CPU 106 may be equipped with wireless transmission capabilities, enabling it to send and receive data without the constraints of physical connections. This wireless capability may be facilitated through various technologies, such as Wi-Fi, Bluetooth, or other suitable wireless communication protocols. The CPU 106 may compile the video data from the first and second cameras 104. This compilation process may involve combining the video data from both cameras 104 into a single data stream, synchronizing the video feeds, or performing other processing tasks to prepare the video data for transmission. In some cases, the CPU 106 may also perform preliminary analysis or processing of the video data, such as image stabilization, resolution enhancement, or other image processing tasks. Once the video data has been compiled, the CPU 106 may transmit the compiled video data to a personal electronic device. This transmission may occur wirelessly, leveraging the wireless transmission capabilities of the CPU 106. The personal electronic device may be any device capable of receiving and processing the transmitted video data, such as a smartphone, laptop, tablet, or other suitable device.

The dual video recording device may include a central processing unit with wireless transmission capabilities for transmitting the captured video to the personal electronic device. This configuration may allow for real-time transmission of the video data, enabling immediate viewing and analysis of the exercise performance. The real-time transmission may also facilitate interactive sessions, where the physical health professional (and/or a trained AI model) can provide immediate feedback to the performer of the exercise. The CPU may store the captured video data for later transmission. This may be useful in scenarios where immediate transmission is not feasible or desirable, such as when the personal electronic device is not within range or when the performer of the exercise prefers to review the video footage at a later time. The stored video data may be transmitted to the personal electronic device when it becomes available or when triggered by a specific event or condition.

In some aspects, the compiled video data may be transmitted to a personal electronic device. This device may be selected from a group consisting of a smartphone and a laptop, among other devices capable of receiving and processing video data. The transmission of video data to the personal electronic device may be facilitated by the wireless transmission capabilities of the CPU 106. In some cases, the video data may be transmitted in real-time, allowing for immediate viewing and analysis of the exercise performance. In other cases, the video data may be stored and transmitted at a later time, depending on the specific requirements or preferences of the user. The personal electronic device may be selected based on the specific requirements or preferences of the user. For instance, a user who prefers a larger display for viewing the exercise performance may opt for a laptop, while a user who prefers portability may opt for a smartphone. Regardless of the type of personal electronic device selected, the system may be configured to transmit the compiled video data to the device for viewing and analysis.

The compiled video data may be transmitted to a website or application for analysis. This website or application may be accessed through the personal electronic device, such as a smartphone or laptop. The website or application may be designed to receive the transmitted video data, display the video feeds, and provide tools for analyzing the exercise performance. In some cases, the website or application may be specifically designed for physical health professionals, providing features and tools tailored to their specific requirements.

The video feeds from the first and second cameras may be displayed side by side on the user interface of the website or application. This side-by-side display may provide a comprehensive view of the exercise performance, allowing the physical health professional to observe the exercise from multiple angles simultaneously. In some cases, the user interface may allow the physical health professional to switch between the video feeds, focus on one feed, or view both feeds simultaneously.

The user interface may provide additional features for analyzing the exercise performance. For instance, the user interface may include tools for pausing the video feeds, rewinding or fast-forwarding the video feeds, zooming in or out, or adjusting the playback speed. These features may enhance the physical health professional's ability to analyze the exercise performance and provide accurate feedback. The user interface may include features for annotating the video feeds. For instance, the user interface may allow the physical health professional to draw on the video feeds, highlight specific areas, or add text annotations. These annotations may be saved along with the video data, providing a record of the analysis for future reference.

The user interface may also provide a section for entering and viewing additional information about the exercise performer. This information may include the performer's physical characteristics, medical history, exercise goals, or other relevant information. The user interface may also provide a section for entering and viewing feedback from the physical health professional. This feedback may be provided verbally or in text form, and may be stored in the database along with the exercise and analysis data.

The website or application may be designed to facilitate the training of AI models. The exercise and analysis data stored in the database may be used to train AI models to analyze exercise performance, provide feedback, or perform other tasks related to physical therapy and personal training. The website or application may include features for managing the AI model training process, such as selecting training data, setting training parameters, monitoring training progress, or evaluating model performance.

A method for analyzing exercise performance may involve capturing video of an exercise performer from two different angles using the dual video recording device. The first and second cameras may be utilized to record the exercise performance from distinct perspectives, providing a comprehensive view of the exercise mechanics. The cameras may be strategically positioned to capture the desired angles, and may be adjustable to accommodate different exercise types or user preferences. The video data captured by the cameras may be transmitted to the CPU, which may compile the data for further processing or transmission.

As shown in FIG. 2, the user interface may include a feature for displaying videos (202-1, 202-2) from two different angles side-by-side, and overlaying a stick figure image (204-1, 204-2) on the performer in the video from each angle. The stick figure image (204-1, 204-2) may be generated (such as by use of an AI model) and overlaid on the video feeds essentially in real-time (202-1, 202-2), providing immediate visual feedback on the exercise performance. The stick figure images (202-1, 202-2) may be generated by using image programs for approximating objects or programs specifically for generating stick figures. The use of learning models may be implemented in the generation, but simpler methods of stick figure generation may be sufficient for the user interface. The use of stick FIGS. 202-1, 202-2) in the user interface may enhance the user's understanding of the exercise mechanics and may assist in identifying and correcting potential inaccuracies in position and/or alignment. The exercise and analysis data may be stored in a database for future reference or AI model training. The stored data may include the video data captured by the cameras, the stick figure image overlaid on the video feeds, and any feedback provided by the user or the physical health professional. This data may be used to train AI models to analyze exercise performance, provide feedback, or perform other tasks related to physical therapy and personal training. The database may be accessible via the personal electronic device, allowing the user or the physical health professional to review the stored data at any time.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system comprising:
a first camera;
a second camera that can be positioned relative to said first camera to cover an overlapping field of view of an exercise area from a different angle;
at least one processor in electrical signal communication with said first and second cameras to receive video data therefrom; and
at least one instruction set that directs said at least one processor to compile video data from said first and second cameras to generate compiled video data that correlates recorded actions taken by a person within the exercise area from two different angles, and directs said processor to perform at least one action selected from the group of:
operating a communications capability to transmit at least a portion of the compiled video data to a physical health professional,
operating a communications capability to transmit at least a portion of the compiled video data to an artificial intelligence capability that employs the recorded actions taken by the person within the exercise area to compare the body positions and/or motion of the person for training at least one machine learning model,
operating a communications capability to transmit at least a portion of the compiled video data to an artificial intelligence capability that performs an analysis of the recorded actions taken by the person within the exercise area to evaluate the body positions and/or motion of the person using at least one machine learning model, and
performing an analysis of the recorded actions taken by the person within the exercise area to compare the body positions and/or motion of the person against at least one reference for proper performance of a specified exercise to provide an indication of compliance.

2. The system of claim 1 wherein said at least one instruction set directs said processor to perform an analysis of the recorded actions taken by the person within the exercise area, wherein the analysis includes generating a stick figure model representing the actions of the person while exercising.

3. The system of claim 2 further comprising a visual display, wherein said at least one instruction set directs said processor to present on the visual display a side-by-side view of at least a portion of the compiled video data from said first and second cameras with a graphic representation based on the stick figure model overlaid onto the views.

4. The system of claim 1 wherein said at least one of processor includes a central processing unit that is mounted in a housing that also houses said first camera.

5. The system of claim 4 wherein said housing is supported on a first tripod and said second camera is supported on a second tripod.

6. The system of claim 5 wherein said at least one instruction set includes instructions for guiding a user in positioning said second camera relative to said first camera to obtain the overlapping field of view of the exercise area from a different angle.

7. The system of claim 1 further comprising:
a first device that houses said first camera and a first CPU that provides at least a portion of said at least one processor and is in electrical signal communication with a personal electronic device selected from the group of a smart telephone, a laptop computer, and a tablet computer, said first device being positionable on legs;
a second device that houses said second camera and is in electrical signal communication with at least one of said first CPU and the personal electronic device, said second device being positionable on legs.

8. The system of claim 1 wherein said first camera, at least a portion of said at least one processor, and at least a portion of said at least one instruction set are provided by an application operating on a personal electronic device selected from the group of a smart telephone, a laptop computer, and a tablet computer.

9. A method comprising the steps of:
recording first camera video data from a first camera positioned to cover a field of view of an exercise area;
recording second camera video data from a second camera positioned to cover an overlapping field of view of the exercise area, from a different angle than the first camera;
compiling the first camera video data and the second camera video data to generate compiled video data that correlates recorded actions taken by a person within the exercise area from two different angles;
employing the compiled video data to perform at least one step selected from the group of:
transmitting at least a portion of the compiled video data to a physical health professional,
transmitting at least a portion of the compiled video data to an artificial intelligence capability that employs the recorded actions taken by the person within the exercise area to compare the body positions and/or motion of the person for training at least one machine learning model,
transmitting at least a portion of the compiled video data to an artificial intelligence capability that performs an analysis of the recorded actions taken by the person within the exercise area to evaluate the body positions and/or motion of the person using at least one machine learning model, and
performing an analysis of the recorded actions taken by the person within the exercise area to compare the body positions and/or motion of the person against at least one reference for proper performance of a specified exercise to provide an indication of compliance.

10. The method of claim 9 comprising the step of performing an analysis of the recorded actions taken by the person within the exercise area, wherein the analysis further comprises the step of generating a stick figure model representing the actions of the person while exercising.

11. The method of claim 10 further comprising the step of generating a visual display showing a side-by-side view of at least a portion of the compiled video data from the first and second cameras with a graphic representation based on the stick figure model overlaid onto the views.

12. The method of claim 9 further comprising the step of guiding a user in positioning the second camera relative to the first camera to obtain the overlapping field of view of the exercise area from a different angle.

13. The method of claim 9 wherein,
said step of recording first camera video data is performed using a first device having a first CPU;
said step of recording second camera video data is performed using a second device; and
said step of compiling the first camera video data and the second camera video data includes the step of transmitting the second camera video data from the second device to at least one of the first device and a personal electronic device selected from the group of a smart telephone, a laptop computer, and a tablet computer.

14. The method of claim 9 wherein said steps of compiling the first camera video data and the second camera video data and employing the compiled video data are performed by an application operating on a personal electronic device selected from the group of a smart telephone, a laptop computer, and a tablet computer.
